(19) United States
(12) Patent Application Publication
(10) Pub. No.: US 2011/0117790 A1
(43) Pub. Date: May 19, 2011

(54) Fastener for separate male terminal block

(75) Inventor: Sheng-Hsing Yeh, Sijhih City (TW)

(73) Assignee: ANYTEK Technology Corporation., Ltd.

(21) Appl. No.: 12/081,582

(22) Filed: Apr. 17, 2008

(51) Int. Cl. H01R 24/00

(52) U.S. Cl. 439/661

(57) ABSTRACT

A fastener for separate male terminal block includes through holes in both sides of a front surface of a male terminal block. Each through hole has a bearing hole with relatively larger diameter and at a bottom thereof. Each bearing hole receives a clip with a screw hole in a center thereof. The clips settle in the bottom of the bearing holes. When screws of a female terminal block extend through the through holes and lock with the clips, the clips reliably bear the locking force of screws and prevent from disengagement under inappropriate force.

### BACKGROUND OF THE INVENTION

(a) Field of the Invention

The present invention relates to a terminal block, and particularly to a fastener for a separate male terminal block.

(b) Description of the Prior Art

Referring to FIGS. 8 and 9, a fastener of a conventional separate male terminal block comprises bearing holes 101 at both sides of the male terminal block 10, and clips 20 interferentially fitting to the bearing holes 101. In the case that the male terminal block 10 electrically connects with a female terminal block 30, screws 301 on both sides of the female terminal block 30 engage with the clips 20, whereby the male terminal block 10 connects with the female terminal block 30 fixedly.

Whereas the clips 20 are implanted into bearing holes 101 from a front surface of the male terminal block 10, which is in the same direction as drawing force produced by the screws 301. The clips 20 are retained only by friction with the bearing holes 101. Therefore, when the screws 301 are pulled backward due to inappropriate force, (for instance, the female terminal block 30 is pulled reverse to the male terminal block 10, or the female terminal block 30 is forced to disengage from the male terminal block 10 as the screws 301 still engage with the clips 20), the clips 20 are brought by the screws 301 off the bearing holes 101, thus destroying electrical connection between the male terminal block 10 and the female terminal block 30.

### SUMMARY OF THE INVENTION

An object of the present invention is to provide a fastener for separate male terminal block which retains electrical connection between the male terminal block and the female terminal block.

Another object of the present invention is to provide a male terminal block which prevents clips against taking off when a female terminal block mated thereto suffers from inappropriate force.

The male terminal block is integrally shaped by plastic injection and defines an elongated slot in a center of a front surface thereof for mating with a female terminal block. A plurality of conductive terminals is implanted in the slot. The fastener for separate male terminal block in accordance with the present invention comprises through holes in a front surface of the male terminal block and at both sides of the slot. Each through hole has a bearing hole with relatively larger diameter and at a bottom thereof. Each bearing hole receives a clip with a screw hole. The clips settle in the bottom of the bearing holes.

### BRIEF DESCRIPTION OF THE DRAWINGS

FIG. 1 is an exploded view of a male terminal block according to the present invention.

FIG. 2 is a perspective view of a male terminal block of FIG. 1 and a female terminal block, wherein male terminal block and the female terminal block are placed separately.

FIG. 3 is a cross sectional view of the male terminal block and the female terminal block, wherein male terminal block and the female terminal block are placed separately.

FIG. 4 is a perspective view of the male terminal block and the female terminal block, wherein male terminal block and the female terminal block are assembled together.

FIG. 5 is a cross sectional view of the male terminal block and the female terminal block, wherein male terminal block and the female terminal block are assembled together.

FIG. 6 is an elevation view of a clip in a second embodiment, wherein the clip is rectangular.

FIG. 7 is an elevation view of a clip in a third embodiment, wherein the clip is hexagonal.

FIG. 8 is an exploded view of a conventional male terminal block.

FIG. 9 is a cross sectional view of a conventional male terminal block and a female terminal block, wherein conventional male terminal block and the female terminal block are placed separately.

### DETAILED DESCRIPTION OF THE PREFERRED EMBODIMENTS

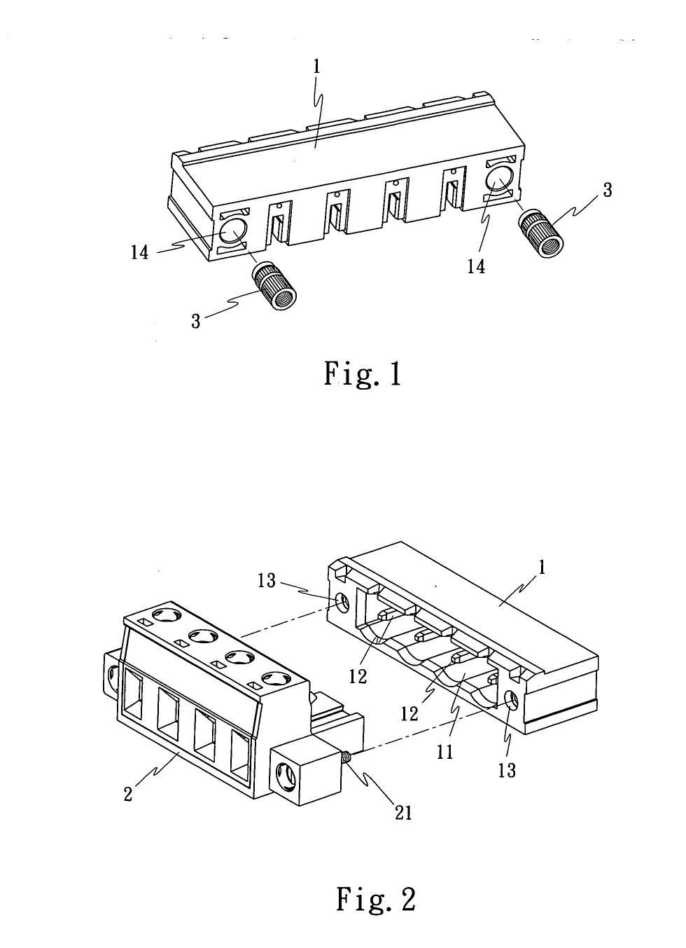

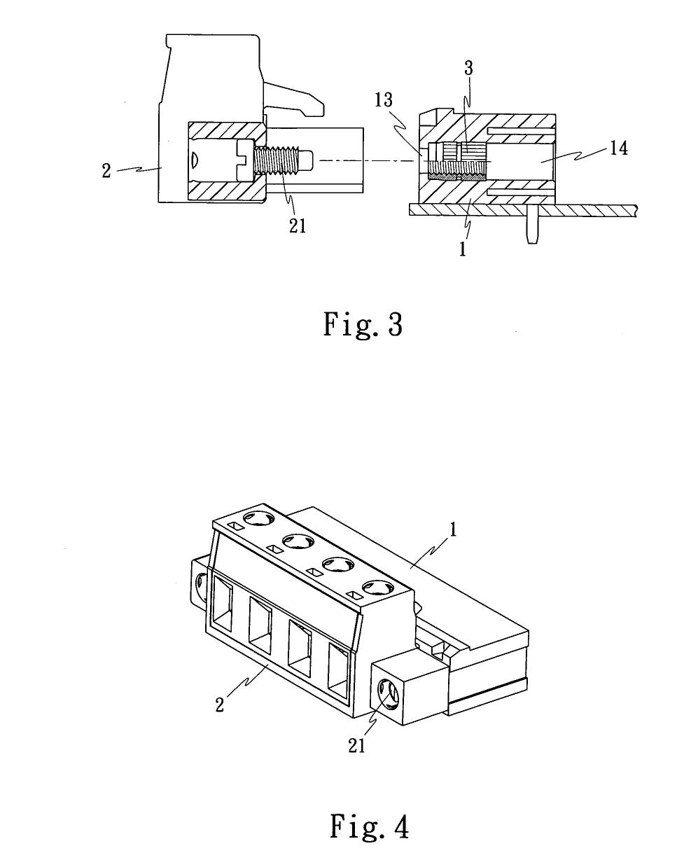

Referring to FIGS. 1, 2 and 3, a separate male terminal block 1 according to the present invention is integrally shaped by plastic injection, and defines an elongated slot 11 substantially in a center of a front surface thereof for mating with a female terminal block 2. The female terminal block 2 has generally common structure as well known by the skilled persons in the art. A plurality of conductive terminals 12 are implanted in the slot 11 for electrically connecting with the female terminal block 2.

The male terminal block 1 defines through holes 13 in a front surface thereof and at both sides of the slot 11. Each through hole 13 has a bearing hole 14 with relatively larger diameter and at a bottom thereof. Each bearing hole 14 receives a clip 3 therein, where the clip 3 settles in the bottom of the bearing hole 14. The clips 3 abut against inner surfaces of the bearing holes 14. Each clip 3 defines a screw hole (not labeled) in a center thereof.

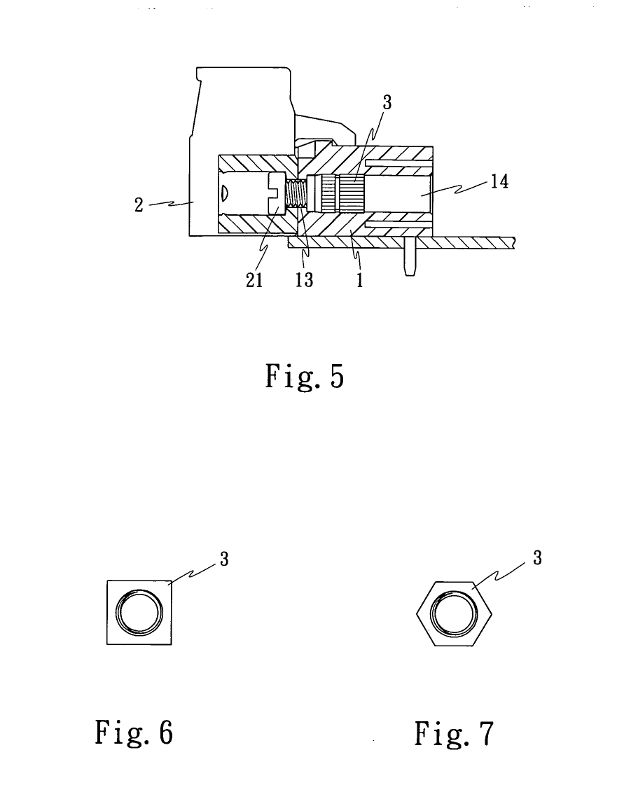

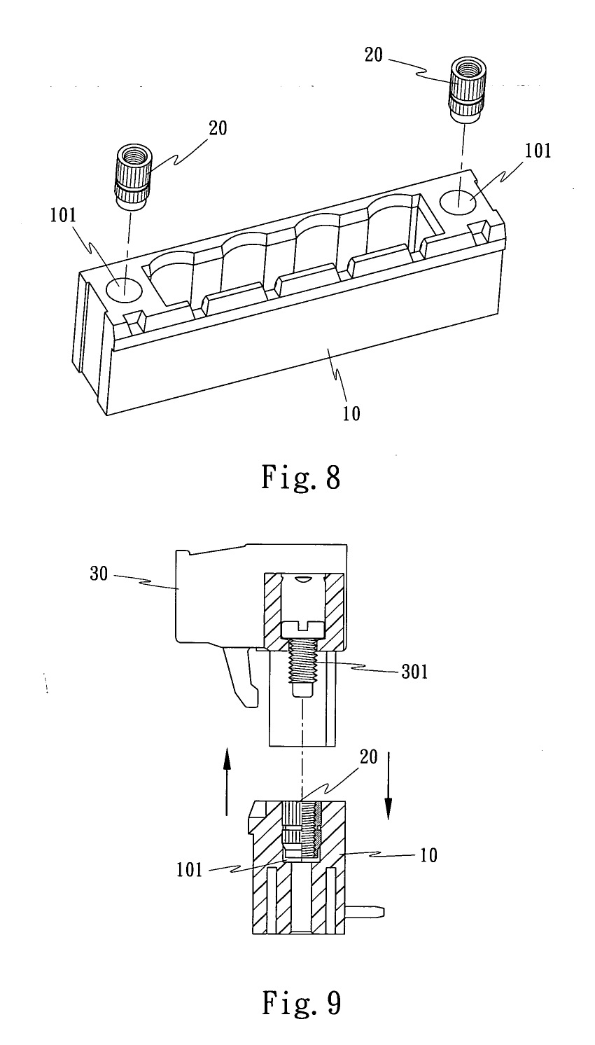

When screws 21 on both sides of the female terminal block 2 extend through the through holes 13 and are retained on the clips 3, as shown in FIGS. 4 and 5, the clips 3 are robust enough to bear the locking force of the screws 21, and will not depart from the bearing holes 14 even in the case of inappropriate force. Accordingly, the female terminal block 2 and the male terminal block 1 are assembled together with retention.

The clips 3 effectively retain the screws 21, avoiding disengagement of the female terminal block 2 from the male terminal block 1. The clips 3 are not confined in shape, for example, the clips 3 may be columniform, as shown in FIG. 1. According to a second embodiment in FIG. 6, the clips 3 are rectangular. According to a third embodiment in FIG. 7, the clips 3 are hexagonal. No matter what shapes the clips 3 are of, the bearing holes 14 have profiles matching up to the shapes of the clips 3 such that the clips 3 fit to the bearing holes 14 and settle in the bottom of the bearing holes 14.

The clips 3 of the present invention are implanted to the bearing holes 14 from a bottom surface of the male terminal block 1. The force suffered by the clips 3 is located at sides of through holes 13. In the case that the female terminal block 2 is forced to depart from the male terminal block 1 while the screws 21 still engage with the clips 3, the clips 3 have retention force to prevent from disengagement.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A fastener for separate male terminal block, the male terminal block being integrally shaped by plastic injection and defining an elongated slot substantially in a center of a front surface thereof for mating with a female terminal block, a plurality of conductive terminals being received in the slot, the fastener comprising through holes in a front surface of the male terminal block and at both sides of the slot, each through hole having a bearing hole with relatively larger diameter and at a bottom thereof, each bearing hole receiving a clip with a screw hole, the clips settling in the bottom of the bearing holes.

2. The fastener for separate male terminal block as recited in claim 1, wherein the clips abut against inner surfaces of the bearing holes.

3. The fastener for separate male terminal block as recited in claim 1, wherein the bearing holes have profiles matching up to the shape of the clips.

4. The fastener for separate male terminal block as recited in claim 1, wherein the clips are columniform.

5. The fastener for separate male terminal block as recited in claim 1, wherein the clips are rectangular.

6. The fastener for separate male terminal block as recited in claim 1, wherein the clips are hexagonal.
